(19) United States
(12) Patent Application Publication
(10) Pub. No.: US 2011/0079074 A1
(43) Pub. Date: Apr. 7, 2011

(54) HYDROGEN CHLORINE LEVEL DETECTOR

(76) Inventor: Saroj Kumar Sahu, Mountain House, CA (US)

(21) Appl. No.: 12/790,794

(22) Filed: May 28, 2010

Related U.S. Application Data
(60) Provisional application No. 61/182,076, filed on May 28, 2009.

(51) Int. Cl. G01N 25/18

(52) U.S. Cl. 73/25.03

(57) ABSTRACT

A method for detecting a ratio of a first substance to that of a second substance in a mixture of substances, includes generating heat in a heating element; measuring a temperature proximate to the heating element; and calculating the ratio of the first substance to that of the second substance from the temperature. In some embodiments, the ratio of the concentrations of hydrogen and chlorine in a mixture of hydrogen and chlorine may be determined.

### PRIORITY CLAIM

This application claims the benefit of U.S. Provisional Application No. 61/182,076, entitled “Hydrogen Chloride Level Detector” filed on May 28, 2009.

### BACKGROUND OF THE INVENTION

1. Field of the Invention

Some embodiments disclosed herein may relate to gas monitoring and, in particular, to methods and systems for measuring and/or monitoring the relative concentrations of gas constituents.

2. Description of the Relevant Art

Many chemical processes produce various gases such as hydrogen, chlorine and oxygen gases. Detection of mixtures of gases is important in order to control reactions and monitor conditions in closed systems. Generally, methods of detecting the composition of gases require the use of expensive equipment (e.g., gas chromatographs). Additionally, it is typically necessary to obtain a sample from the container that includes the mixture of gases. Furthermore, some chemical reactions involving certain gases, such as hydrogen and chlorine gas, may be hazardous if not performed in a controlled manner.

Exemplary systems for determining the compositions for a mixture of gases are described in U.S. Pat. No. 4,226,112 and U.S. Pat. No. 4,891,629. These systems generally rely on the use of thermal conductivity measurements made with respect to a reference gas. In this way a relative measurement may be made and correlated to the concentration of the gases in the mixture. The reliance of the use of a reference gas, however, may cause difficulties if a sample cannot easily be obtained. Additionally, the use of reference samples makes in situ analysis difficult or impossible.

There is therefore a need for a sensor that can be placed in a reaction vessel and detect concentrations of gaseous components produced by various chemical processes.

### SUMMARY OF THE INVENTION

A sensor system for detecting a ratio of a first substance to that of a second substance in a gaseous mixture of the first and second substances, wherein the first substance and the second substance have substantially different thermal conductivities, the sensor system including a temperature sensor, capable of measuring the temperature of the gaseous mixture; a pressure sensor capable of measuring the pressure of the gaseous mixture; and a thermistor.

A method for detecting a ratio of a first substance to that of a second substance in a gaseous mixture, the method including: placing a sensor in an environment comprising the gaseous mixture, having a known temperature and pressure, the sensor comprising a thermistor operating a dissipative mode and carrying a prescribed current; measuring a voltage change across the thermistor; and determining the ratio of the first gas to that of the second gas from the measured voltage after and gas dependent constant corrections are applied.

A sensor system for detecting a ratio of a first substance to that of a second substance in a gaseous mixture of the first and second substances, wherein the first substance and the second substance have substantially different thermal conductivities, the sensor system including: a thermistor; and a resistor coupled in series to the thermistor; wherein the resistor is selected according to the following method: measuring the voltage across the thermistor when the thermistor is placed in a gaseous mixture of the first substance and the second substance having a known concentration molar ratio; comparing the measured voltage to a standard voltage; and selecting a resistor that, when placed in series with the thermistor, will alter the measured voltage of the thermistor to be substantially equal to the standard voltage.

### BRIEF DESCRIPTION OF THE DRAWINGS

Advantages of the present invention will become apparent to those skilled in the art with the benefit of the following detailed description of embodiments and upon reference to the accompanying drawings in which:

FIG. 1 depicts an embodiment of a concentration sensor;

FIG. 2 depicts a plot that may be used by a sensor system;

FIG. 3 depicts a thermistor;

FIG. 4 depicts a thermistor based concentration sensor system;

FIG. 5 depicts a plot of the voltage vs. the concentration molar ratio of Cl₂:H₂;

FIG. 6 depicts a plurality of plots of the voltage vs. the concentration molar ratio for different thermistors; and

FIG. 7 depict an alternate embodiment of a thermistor detection system.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF THE PREFERRED EMBODIMENTS

It is to be understood the present invention is not limited to particular devices or methods, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise.

Embodiments of a gas sensor are described below that measure the relative concentrations of two or more gases in a gaseous mixture. It should be understood that the sensor may be applicable to many applications. One particular application relates to detecting the relative concentrations of hydrogen and chlorine in a gaseous mixture. Thus, although embodiments are described with reference to measurement of the relative concentrations of chlorine and hydrogen, sensors according to some embodiments may be capable of measuring the relative concentrations of other gas mixtures, such as oxygen and hydrogen, as well.

An objective of the gas sensor is to have the capability of measuring the relative concentration of two or more gases using a single temperature probe in the absence of a reference gas. It is a further objective that, with a known gas system, we should be able to measure compositions using a hardware system that does not rely on significant software compensation.

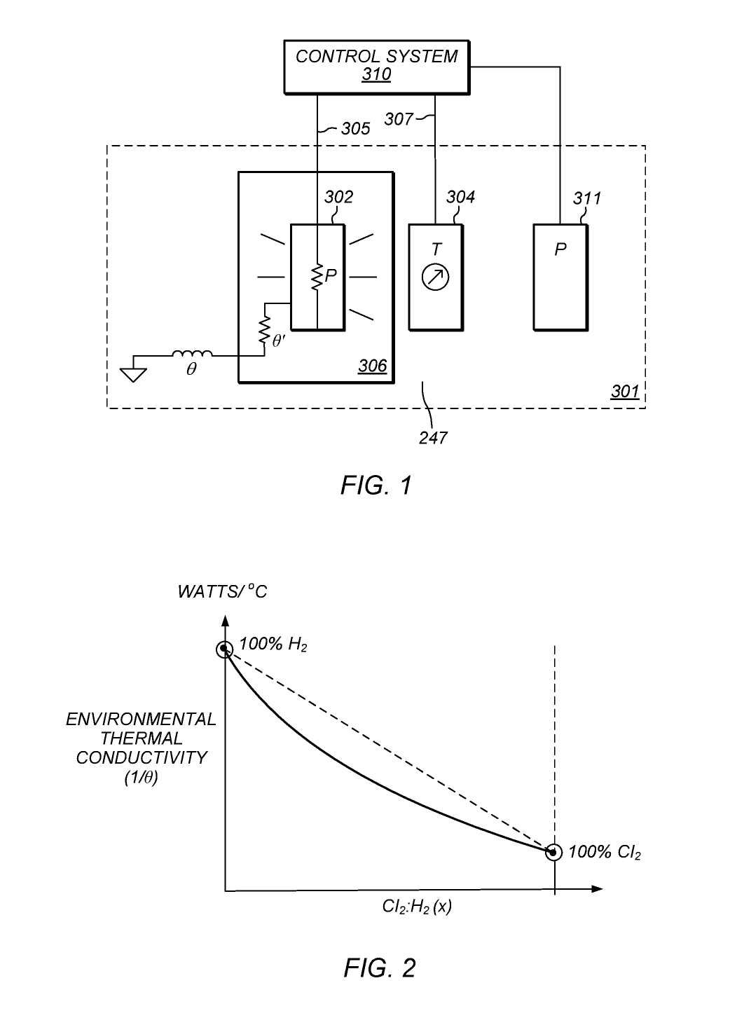

FIG. 1 depicts an equivalent thermal circuit diagram illustrating the operation of a sensor. Enclosure thermal resistivity and environment thermal resistivity are depicted as (equivalent) resistors θ′ and θ, respectively. Heat element 302 (e.g., a thermistor) may generate a net power P by receiving (via line 305) a signal, such as a constant current, constant voltage, or any other signal capable of generating a net power across heat element 302. For example, heat element 302 may generate net heat P by receiving, from a known voltage source V, a current I via line 305. Temperature sensing element 304 may provide (via line 307) a temperature reading T associated with environment 301. Pressure sensing element 311 may provide a pressure reading p associated with environment 301. It should be understood that temperature reading T may include any value that corresponds directly or indirectly to a given temperature sensed by temperature sensing element 304. In some embodiments, when no heat is generated across heat element 302, temperature sensing element 304 may indicate an ambient temperature reading Tₐ associated with environment 301.

As seen in FIG. 1, heat generated by heat element 302 may be transferred to environment 301 and may raise the temperature at temperature sensing element 304 (temperature reading T). The temperature read by temperature sensing element 304 depends on the heat (power) P generated across heat element 302 and the heat transferred to environment 301. The rate at which heat P is transferred through environment 301 depends on the enclosure 306 thermal resistivity θ′ and environmental thermal resistivity θ. As discussed above θ′ may be negligible when compared with θ, therefore;

T=function(P,θ) (1)

Furthermore, as discussed earlier with respect to FIG. 1, environmental thermal resistivity θ also depends on a ratio x of the concentrations of the first and second gases. Therefore,

T=function(P,θ,x) (2)

As seen from equation 2, ratio x of the concentration of the first and second gases may be computed from temperature reading T received from temperature sensing element 304. In some embodiments, the relationship between θ and x is derived from one or more plots typically developed from laboratory measurements under controlled conditions, see FIG. 2. In some embodiments, corresponding values of θ and x derived from the plots mentioned above may be stored in a memory (not shown) that may be included as part of control and feedback circuitry 310.

Furthermore, in some embodiments, sensor 247 may be coupled to the control and feedback system 310 (via lines 305 and 307) and may be configured to calculate x based on temperature reading T and accordingly adjust the proportion (concentration) of the first and second gases in the mixture such that a controlled reaction may be maintained.

As mentioned above, FIG. 2 is an exemplary plot depicting the relation between environmental thermal conductivity (1/θ) and ratio x for a mixture of Cl₂ and H₂ gases. Plot depicts Cl₂:H₂ relative concentration ratio x on the x-axis and environmental thermal conductivity (1/θ) on the y-axis. As seen in FIG. 2, for a given θ, a corresponding value of ratio x may be obtained. Furthermore, as discussed above, corresponding values of θ and x derived from the plot may be stored in a memory included as part of relevant control and feedback circuitry 310.

In one embodiment, temperature sensing element 304 is a thermocouple. A thermocouple may be configured to provide a voltage reading V′ in response to a temperature T sensed by temperature sensing element 304. A net power P may be generated across heat element 302. Changes in the temperature of the environment sensed by thermocouple 402 may, in turn, cause voltage reading V′ to appear at thermocouple 402. In some embodiments, the relationship between V′ and temperature T sensed by thermocouple 402 is derived from one or more plots typically developed from laboratory measurements under controlled conditions. In some embodiments, corresponding values of T and V′ derived from the plots mentioned above may be stored in a memory (not shown) that may be included as part of control and feedback circuitry. Furthermore, once temperature T is computed from voltage reading V′, ratio x may be computed in a manner similar to that discussed with respect to equation 2, and control and feedback system 310 may accordingly adjust the proportion (concentration) of the gases in the mixture as necessary.

In another embodiment, heat element 302 may be a thermistor having a resistance R that varies as a function of a temperature T sensed by the environment surrounding the thermistor. A net power P may be generated across thermistor acting as a heat element. For example, if net power P is generated across thermistor from known voltage source V and current I, then:

P=I²*R (3)

furthermore the relationship between R and T may be expressed by the Steinhart-Hart equation as:

$$\frac{1}{T} = \frac{1}{{T}_{0}} + \frac{1}{B} ln ( \frac{R}{{R}_{0}} ) \qquad ( 4 )$$

where Rₒ is the resistance of thermistor at a reference temperature T₀ and B is a device constant. Typically, R₀, T₀, and B are included as part of the manufacturer's specifications associated with thermistor.

The power produced by the thermistor is related to the thermal conductivity of the gaseous mixture that the thermistor is immersed in. For example, the thermistor power P_{TH} can be characterized as follows:

P_{TH}=i_{C}²*R_{TH}=(T_{Th}−T_{Am})σ_{ABX}*C_{TH}

Where i_{C} is the constant current, R_{TH} is the resistance of the thermistor; T_{Th} is the temperature of the thermistor; T_{Am} is the ambient temperature, and C_{TH} is a constant related to the thermistor. σ_{ABX} is the thermal conductivity of a mixture of gases A and B having a molar ratio x. Since σ_{ABX}=f(x, σ_{A}, σ_{B}) the molar ratio x can be determined as:

x=f(σ_{A},σ_{B},P_{Am},T_{Am},i_{c}C_{Th})*K(V_{TH})

Thus the apparatus schematically depicted in FIG. 1 can be used to determine the molar ratio of a binary gaseous mixture by providing the variables P_{Am} (from pressure sensor 311), T_{Am} through temperature sensor 304, and V_{TH} measured across thermistor during use. Variables σ_{A}, σ_{B}, i_{c} C_{Th} are either known or preselected. In this manner a thermistor based sensor system, that includes a temperature sensor and a pressure sensor may be used to determine the concentration molar ratio of two substances in a gaseous mixture without having to take a sample and without the need for a reference gas.

Since the thermal conductivity of the gaseous mixture is related to the concentration molar ratio, x,

When no heat is generated across thermistor (i.e. no signal is applied across line 305), resistance R of thermistor corresponds to temperature Tₐ of environment. When a heat P is generated across thermistor, then the heat transferred (Pₜ) between thermistor and the surrounding environment may be expressed as:

Pₜ=K(T−Tₐ) (5)

where K is the coefficient of heat transfer. Moreover, in an equilibrium condition:

P=Pₜ (6)

therefore from equations 3, 4, and 5,

I²R=K[B/Ln(R/R_{inf})−Tₐ] (7)

where,

R_{inf}=R₀e^{-B/T}₀

Therefore, as can be seen from equation 7, because I, B, and R_{inf} may be known quantities,

R=function(K,Tₐ) (8)

and because V=I*R (from Ohm's law),

V=function(K,Tₐ) (9)

Furthermore, because K is the heat transfer coefficient between thermistor and environment 301, K is directly related to environmental thermal resistivity θ which further depends on ratio x. Therefore, from equation 9:

V=function(x,Tₐ) (10)

From equation 10, the ratio of the two gases is derived from known voltage source V and temperature Tₐ. In some embodiments, corresponding values of Tₐ and V derived from equation 4 discussed above, may be stored in a memory (not shown) that, for example, is included as part of control and feedback circuitry 310.

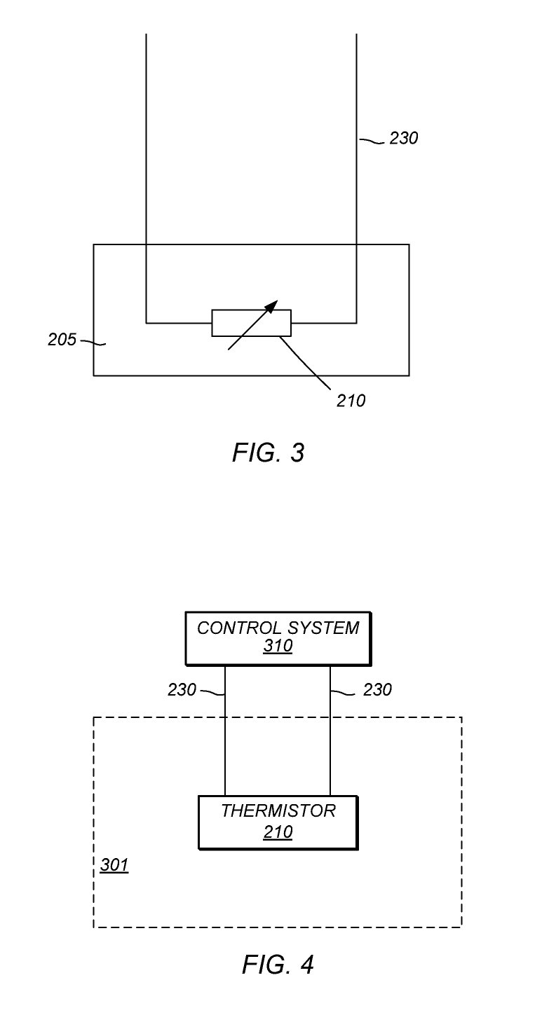

FIG. 3 illustrates a thermistor assembly 200. Thermistor 210 can be made from such materials as metal oxides, ceramic or polymer. To protect thermistor 210 from operating atmosphere, humidity, chemical attack, and contact corrosion, thermistor 210 can be coated with encapsulant 205. Encapsulant 205 can be made from such materials as polytetrafluoroethylene, glass, epoxy, silicone, ceramic cement, lacquer, and urethane. Lead wires 230 are electrically connected to the terminals of thermistor 210. Lead wires 230 can be made from such materials as copper, aluminum, silver, gold, nickel, or an alloy, and can be tin or solder coated. Lead wires 230 can be insulated to protect lead wires 230 from operating atmosphere, humidity, chemical attack, and contact corrosion.

Thermistor 210 is a type of resistor whose resistance (R) varies with temperature (T).

ΔR=k*ΔT

where ΔR is the change in resistance, k is the temperature coefficient, and ΔT is the change in temperature. If k is positive, the resistance increases with increasing temperature, and the device is called a positive thermistor. If k is negative, the resistance increases with decreasing temperature, and the device is called a negative thermistor. As can be appreciated by one of ordinary skill in the art, thermistor 210 can be selected so that the relationship between temperature and resistance is approximately linear over the temperature range in which thermistor 210 will operate.

The change in resistance of the thermistor is not, typically directly measured. Instead, it is easier to measure the voltage across the thermistor and from this reading determine the resistance. Voltage is related to resistance according to Ohm's law:

V=I*R

Thus, if the current is constant, the resistance of the thermistor is directly related to the voltage measured across the thermistor. Thus, ΔR described above, can be replaced with ΔV, which can be directly measured.

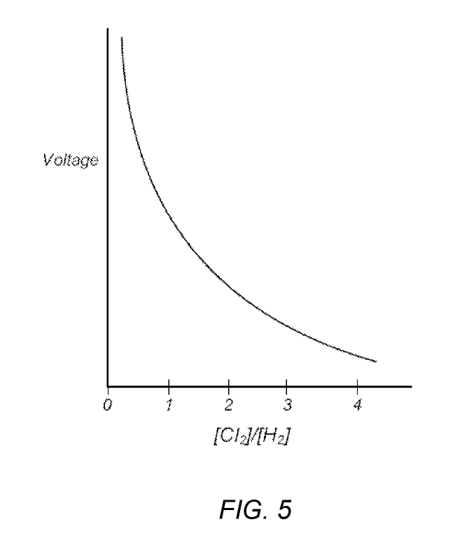

Thermistor 210 may be used to detect the molar concentration ratio of two gases in an enclosed system. An exemplary system for determining the concentration of two gases is depicted in FIG. 4. Thermistor 210 is exposed to a mixture of gas in environment 301. Thermistor 210 is subjected to a constant current using control system 310. The current is set, such that thermistor 210 is operated in a dissipative mode. As used herein, the term “dissipative mode” refers to a condition where sufficient current is flowing through the thermistor to cause the temperature of the thermistor to rise to a point such that the difference in temperature between the thermistor and the ambient environment in which the thermistor is positioned is greater than 10 C. The heat generated by the thermistor in dissipative mode dissipates and heats up environment 301. The rate of cooling of the thermistor, by virtue of the dissipation of heat, is a function of the thermal conductivity of the environment. The thermal conductivity of the environment is directly related to the molar ratio of the concentration of the two gases. The dissipation of heat generated by the thermistor results in a change of resistance. The change in resistance is indirectly measured by observing the voltage across the thermistor. FIG. 5 depicts a typical graph of the voltage measured across a thermistor with respect to the molar ratio of the concentration of a binary gas mixture (e.g., Cl₂ and H₂). As used herein the term “concentration molar ratio” refers to the ratio of the concentration of the first gas in the mixture with respect to the concentration of the second gas.

In one embodiment, the behavior one or more thermistors is determined with respect to a specific gas mixture. In a method, a thermistor is immersed in a binary gas mixture. The voltage measured across the thermistor is measured when a constant current is applied to the thermistor, when the thermistor is immersed in a binary gas mixture having a know concentration molar ratio. The concentration molar ratio is altered and the voltage is again measured. In this manner a plot, such as depicted in FIG. 5 may be generated and used to determine the concentration molar ratio of a unknown binary mixture of gases.

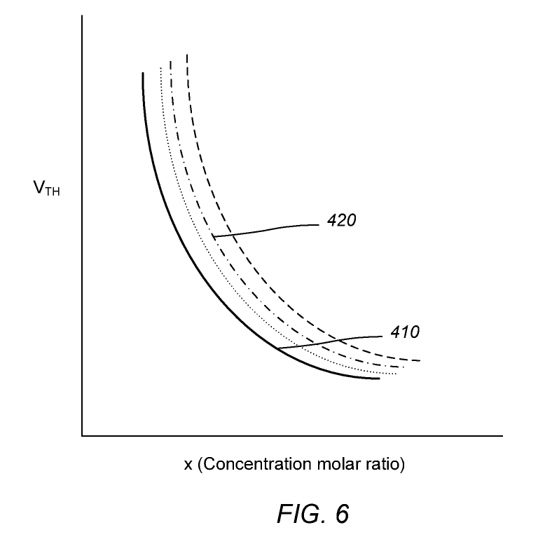

Voltage data collected at a constant current for various concentration molar ratios can be represented graphically as depicted in FIG. 5. This process may be performed using different thermistors to generate a relationship diagram, such as depicted in FIG. 6, where the each line represents a series of test run on a different thermistor. As can be seen in FIG. 6, each thermistor can have its own band, and leading to different plots used with different thermistors. In one embodiment, to ensure the accuracy of each test run with a selected thermistor, such a plot should be generated using the thermistor in a test simulation, as described above.

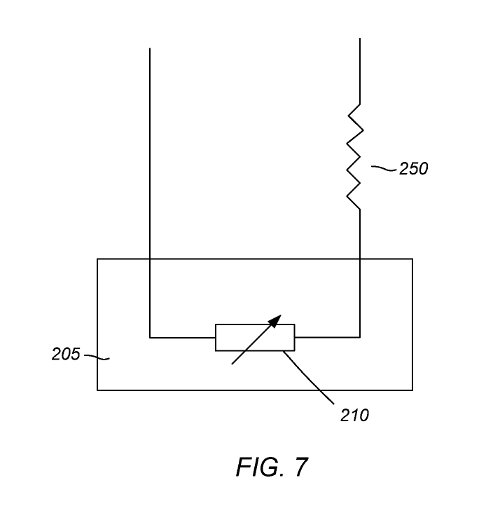

In some embodiments, a resistor, or potentiometer, may be placed in series with the thermistor, as depicted in FIG. 7, to modify the operating characteristics of the thermistor. In one embodiment, plots of voltage vs. concentration molar ratio is measured for a plurality of thermistors, as depicted in FIG. 6. A reference band, e.g., the band related to thermistor 410, may be selected for use in a controller for determining the molar ratio of a mixture of two gases. When thermistor 420 is selected for use, the detected concentration molar ratio will not be accurate if thermistor 420 is used with the same controller used for thermistor 410. This error can be corrected for by reprogramming controller 310, for example. Alternatively, a resistor may be placed in series with the thermistor to alter the voltage read across thermistor 420, such that thermistor 420 operates in a manner substantially identical with thermistor 410.

In one embodiment, a reference band 410, derived from a first thermistor, representing a plot of voltage vs. concentration molar ratio for the first thermistor may be selected. The voltage across a second thermistor may be measured under conditions that are identical to at least one of the conditions that correspond to a point along reference plot 410. For example, thermistor may be placed in a contained having a known concentration corresponding to a concentration molar ratio corresponding to a point along reference band 410. Under identical testing conditions (e.g., same temperature and pressure, same gas composition), the voltage across the second thermistor may be measured. The difference between the measured voltage, V_{Mea} and the reference voltage, V_{Ref}, can be used to select a resistor to place in series with the second thermistor, so that the resistance (and thus the measured voltage across the second thermistor) of the second thermistor more closely matches the resistance of the first thermistor. Placing the selected resistor in series with the second thermistor allows the reaction of the second thermistor to the gas mixture to be substantially the same as the first thermistor.

Selection of the resistor may be performed by use calculating the theoretical resistance required to alter the voltage of the second thermistor to match the first thermistor under identical test conditions. Alternatively, a variable resistor (e.g., a potentiometer) may be coupled in series with the second thermistor. Second thermistor may be placed in a known environment matching an environment encompassed by reference band 410. The voltage of the second thermistor is measured and compared to the voltage measured under the same conditions for reference band 410. If the measured voltage is too high, the variable resistor may be activated and adjusted until the measured voltage matches the voltage from reference band 410, under the same conditions. The second thermistor/resistor pair may be used to measure the concentration of unknown mixtures, and is expected to have a same response as the first thermistor.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A sensor system for detecting a ratio of a first substance to that of a second substance in a gaseous mixture of the first and second substances, wherein the first substance and the second substance have substantially different thermal conductivities, the sensor system comprising:
a temperature sensor, capable of measuring the temperature of the gaseous mixture;
a pressure sensor capable of measuring the pressure of the gaseous mixture; and
a thermistor.

2. The sensor system of claim 1, wherein the thermistor is operated in dissipative mode.

3. The sensor system of claim 1, wherein the sensor is configured to detect the concentration molar ratio of a mixture of hydrogen gas and chlorine gas.

4. The sensor system of claim 1, wherein the sensor is configured to detect the concentration molar ratio of a mixture of hydrogen gas and oxygen gas.

5. The sensor system of claim 1, wherein said thermistor is an encapsulated thermistor, and wherein when the thermistor is operated in dissipative mode the temperature of the thermistor (Tₜₕ), the encapsulation surface temperature (Tₑₙ), and the ambient temperature Tₐₘ are such that at a current below the rated current of the thermistor, the thermistor meets the following conditions:
Tₜₕ−Tₑₙ<Tₐₘ−Tₑₙ−10 C

6. The sensor system of claim 1, wherein the temperature sensing element is a thermocouple, resistance temperature sensor, or a thermistor in a non-dissipative mode.

7. A method for detecting a ratio of a first substance to that of a second substance in a gaseous mixture, the method comprising:
placing a sensor in an environment comprising the gaseous mixture, having a known temperature and pressure, the sensor comprising a thermistor operating a dissipative mode and carrying a prescribed current;
measuring a voltage change across the thermistor; and
determining the ratio of the first gas to that of the second gas from the measured voltage after and gas dependent constant corrections are applied.

8. The method of claim 7, wherein the first substance is hydrogen and the second substance is chlorine.

9. The method of claim 7, wherein the first substance is hydrogen and the second substance is oxygen.

10. The method of claim 1, further comprising measuring the temperature of the environment using a temperature sensor, prior to placing the thermistor in dissipative mode.

11. The method of claim 1, wherein said thermistor is an encapsulated thermistor, and wherein when the thermistor is operated in dissipative mode the temperature of the thermistor (Tₜₕ), the encapsulation surface temperature (Tₑₙ), and the ambient temperature Tₐₘ are such that at a current below the rated current of the thermistor, the thermistor meets the following conditions:
Tₜₕ−Tₑₙ<Tₐₘ−Tₑₙ−10 C

12. A sensor system for detecting a ratio of a first substance to that of a second substance in a gaseous mixture of the first and second substances, wherein the first substance and the second substance have substantially different thermal conductivities, the sensor system comprising:
a thermistor; and a resistor coupled in series to the thermistor;
wherein the resistor is selected according to the following method:
measuring the voltage across the thermistor when the thermistor is placed in a gaseous mixture of the first substance and the second substance having a known concentration molar ratio;
comparing the measured voltage to a standard voltage; and
selecting a resistor that, when placed in series with the thermistor, will alter the measured voltage of the thermistor to be substantially equal to the standard voltage.

13. The sensor system of claim 12, wherein the standard voltage is determined by measuring the voltage across a plurality of thermistors, when immersed in a plurality of gaseous mixtures of the first and second substances, each mixture having a known concentration molar ratio and selecting a standard voltage from one of the plurality of measured voltages.

14. The sensor system of claim 12, wherein the sensor is configured to detect the concentration molar ratio of a mixture of hydrogen gas and chlorine gas.

15. The sensor system of claim 12, wherein the sensor is configured to detect the concentration molar ratio of a mixture of hydrogen gas and oxygen gas.
